(19) United States
(12) Patent Application Publication
(10) Pub. No.: US 2023/0318050 A1
(43) Pub. Date: Oct. 5, 2023

(54) BATTERY PACK, AN ELECTRIC VEHICLE AND A METHOD FOR ASSEMBLING A BATTERY PACK

(71) Applicant: SAMSUNG SDI CO., LTD., Yongin-si (KR)

(72) Inventors: Markus Ridisser, Premstätten (AT); Florian MAXL, Graz (AT)

(21) Appl. No.: 18/127,573

(22) Filed: Mar. 28, 2023

(30) Foreign Application Priority Data
Mar. 30, 2022 (EP) 22165612.7
Mar. 28, 2023 (KR) 10-2023-0040645

(51) Int. Cl. H01M 10/42; H01M 50/505; B60L 50/64; H01M 50/516; H01M 50/204

(52) U.S. Cl. CPC H01M 10/425; H01M 50/505; B60L 50/64; H01M 50/516; H01M 50/204; H01M 2010/4271; H01M 2220/20

(57) ABSTRACT

A battery pack includes: a plurality of battery cells; a battery management module (BMM); a plurality of sensor devices and/or a plurality of current collector devices; and a flexible conductor arrangement including a plurality of conductor lines, a flexible printed circuit (FPC), and a plurality of flexible flat cables (FFCs) connected to the FPC. The conductor lines are routed along the FPC and branch into the plurality of FFCs, and each of the conductor lines electrically interconnects the BMM with one of the sensor devices, one of the current collector devices, and/or one of the battery cells via the FPC and via one of the FFCs.

### CROSS-REFERENCE TO RELATED APPLICATIONS

This application claims priority to and the benefit of European Patent Application No. 22165612.7, filed in the European Patent Office on Mar. 30, 2022, and Korean Patent Application No. 10-2023-0040645, filed in the Korean Intellectual Property Office on Mar. 28, 2023, the entire content of both of which are incorporated herein by reference.

### BACKGROUND

### 1. Field

Aspects of embodiments of the present disclosure relate to a battery pack, an electric vehicle, and a method for assembling a battery pack.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

Static control of battery power output and charging may not be sufficient to meet the dynamic power demands of various electrical consumers connected to the battery system. Thus, steady exchange of information between the battery system and the controllers of the electrical consumers may be implemented. This information includes the battery system's actual state of charge (SoC), potential electrical performance, charging ability, and internal resistance, as well as actual or predicted power demands or surpluses of the consumers. Therefore, battery systems usually include a battery management system (BMS) for obtaining and processing such information on a system level and further include a plurality of battery module managers (BMMs), which are part of the system's battery modules and obtain and process relevant information on a module level. The BMS usually measures the system voltage, the system current, the local temperature at different places inside the system housing, and the insulation resistance between live components and the system housing. And the BMMs usually measure the individual cell voltages and temperatures of the battery cells in a battery module.

Thus, the BMS/BMM is provided for managing the battery pack, such as by protecting the battery from operating outside its safe operating area (or safe operating parameters), monitoring its state, calculating secondary data, reporting that data, controlling its environment, authenticating it, and/or balancing it.

In case of an abnormal operation state, a battery pack may usually be disconnected from a load connected to a terminal of the battery pack. To this end, battery systems further include a battery disconnect unit (BDU) that is electrically connected between the battery module and battery system terminals. Thus, the BDU is the primary interface between the battery pack and the electrical system of the load, such as the vehicle. The BDU includes electromechanical switches that open or close high current paths between the battery pack and the electrical system. The BDU provides feedback to a battery control unit (BCU) accompanying the battery modules, such as voltage and current measurements. The BCU controls the switches in the BDU by using low current paths based on the feedback received from the BDU. The BDU may control current flow between the battery pack and the electrical system and sense current. The BDU may further manage external charging and pre-charging.

Battery packs for electric vehicles according to the related art usually include a plastic carrier with integrated cell-sensing devices. Information (or data) from these cell-sensing devices is collected via a cost intensive, complex, and heavy cable arrangement, which is routed through the entire battery pack to one central BMM. In other cases, decentral (or decentralized) BMMs are arranged on top of cell stacks formed by a plurality of battery cells stacked together. In this case, however, the BMMs need to be connected with each other. The BMMs and the interconnections therebetween are rigid parts that utilize valuable space on top of the cells. The BMMs also need to be connected to the BDU. Thus, there is a large amount of voltage and/or temperature sensing within the battery pack with a large number of cables, which have to be fixed, leading to additional parts, such as cable clips.

### SUMMARY

The present disclosure is defined by the appended claims and their equivalents. Any disclosure lying outside the scope of the claims and their equivalents is intended for illustrative as well as comparative purposes.

According to one embodiment of the present disclosure, a battery pack includes a plurality of battery cells, a battery management module (BMM), a plurality of sensor devices and/or a plurality of current collector devices, and a flexible conductor arrangement including a plurality of conductor lines, a flexible printed circuit (FPC), and a plurality of flexible flat cables (FFCs) connected to the FPC. The conductor lines are routed along the FPC and branch into the plurality of FFCs, and each of the conductor lines electrically interconnects the BMM with one of the sensor devices, one of the current collector devices, and/or one of the battery cells via the FPC and via one of the FFCs.

According to another embodiment of the present disclosure, an electric vehicle includes a battery pack as described above.

Yet another embodiment of the present disclosure provides a method for assembling a battery pack. The method includes: providing a plurality of battery cells, a battery management module (BMM), a plurality of sensor devices and/or a plurality of current collector devices, and a flexible conductor arrangement including a plurality of conductor lines, a flexible printed circuit (FPC), and a plurality of flexible flat cables (FFCs) connected to the FPC, the conductor lines being routed along the FPC and branch into the plurality of FFCs; and electrically interconnecting each of the sensor devices, current collector devices, and/or battery cells with the BMM by one of the conductor lines via the FPC and via one of the FFCs.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic view of an electric vehicle according to an embodiment of the present disclosure.

FIG. 2 is a perspective view of a portion of a battery pack according to an embodiment.

FIG. 3 is a top view of a portion of a battery pack according to an embodiment.

FIG. 4 is a perspective view of a portion of a battery pack according to an embodiment.

FIG. 5 is a perspective view of a flexible conductor arrangement.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure may, however, be embodied in various different forms and should not be construed as being limited to the embodiments illustrated herein. Rather, these embodiments are provided as examples so that this disclosure will be thorough and complete, and will fully convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

According to an embodiment of the present disclosure, a battery pack includes a plurality of battery cells, a battery management module (BMM), a plurality of sensor devices and/or a plurality of current collector devices, and a flexible conductor arrangement including a plurality of branched conductor lines. The BMM is configured to obtain and process information acquired by the plurality of sensor devices. Each of the current collector devices is configured to deliver an electric current from one or more of the battery cells to the BMM.

The flexible conductor arrangement includes the plurality of branched conductor lines. The conductor lines are flexible and can be effectively arranged at different positions within the battery pack. The conductor lines are branched, that is, a plurality of the conductor lines have a first section in which the plurality of the conductor lines is arranged at (or routed along) essentially the same path. For example, individual conductor lines from among the plurality of the conductor lines are arranged in parallel to each other while being electrically isolated from each other, and the plurality of the conductor lines have a second section in which the plurality of conductor lines are arranged at different paths through the battery pack. A branch portion is arranged between the first section and the second section at where individual conductor lines from among the plurality of conductor lines branch from each other.

The flexible conductor arrangement includes a flexible printed circuit (FPC) and a plurality of flexible flat cables (FFCs) connected to the FPC. The FPC includes a flexible substrate and is configured to provide (or form) a portion of the conductor lines. The FFC is an electric cable that is flat and flexible and is configured to provide (or form) a portion of the conductor lines. The conductor lines are routed along the FPC and the FFCs. Each of the conductor lines branch at a branch portion of the FPC into one of the plurality of FFCs. Thus, the FPC includes a plurality of branch portions, and at each of the branch portions, the FPC branches into one of the plurality of FFCs. Thus, the FPC provides the above mentioned first section in which the plurality of conductor lines are arranged in parallel to each other, and the FFCs provide the second section in which the plurality of conductor lines are arranged at different paths. The flexible conductor arrangement including the FPC and the plurality of FFCs provides improved arrangement of conductor lines. For example, the FPC allows an effective arrangement of conductor lines, and the FFCs allow a cost-effective and efficiently manufacturable arrangement of conductor lines.

Each of the conductor lines electrically interconnects the BMM via the FPC and via one of the FFCs with one of the sensor devices, one of the current collector devices, and/or one of the battery cells. The FPC acts as a collector for all the conductor lines and routes the conductor lines to the BMM to reduce wiring. In other words, embodiments of the present disclosure provide a cell-sensing and current collection arrangement using an FFC and FPC combination for a flexible positioning of the BMM. Embodiments of the present disclosure provide a flexible conductor arrangement which combines features of FPCs, such as a plurality of parallel conductor lines that can be effectively arranged, and FFCs, such as cost-efficient and an effective manufacturability. Plastic parts and cables, which are used to hold battery pack-spanning busbars and cell sensing devices, can be omitted. The FPC is adaptable to the shape and geometry of the flexible substrate below the FPC, such as the battery cells, a longitudinal beam, and/or a crossbeam, and is easily mechanically fixed. Thus, wiring throughout the entire battery pack can be reduced or minimized, irrespective of the installation position of the BMM. The number of plugs and additional electrical components can be reduced to save weight and costs and to decrease the complexity of the battery pack and its manufacturability.

According to an embodiment, the FPC includes a plurality of electrically conducting layers separated from each other by at least one electrically isolating layer. For example, one electrically isolating layer is arranged between any pair of electrically conducting layers. This allows a plurality of conductor lines within the FPC to be arranged efficiently and in a space-saving manner. Compared to a single conducting layer or a flat cable, by providing the plurality of electrically conducting layers, the number of conductor lines can be increased by a factor of the number of electrically conducting layers. In some embodiments, the number of electrically conducting layers equals the number of FFCs or the number of conductor lines being provided by a single FFC. This further reduces wiring and simplifies the connection between the FPC and the FFCs.

According to an embodiment, one of the plurality of FFCs is electrically connected to each of the electrically conducting layers of the FPC. Because the width of the FPC does not depend on the number of FFCs connected to the FPC, additional space-saving may be achieved.

According to an embodiment, the battery cells are electrically interconnected by a busbar, and the FPC includes a metal portion arranged at a welding position, electrically isolated from the conductor lines, and welded to the busbar. Alternatively or additionally, the busbar may include a metal portion arranged at a welding position, electrically isolated from the conductor lines, and welded to the FPC. This enables reliable mechanical fixation of the flexible conductor arrangement within the battery pack. Because the metal portion is electrically isolated from the conductor lines, any unintended interference of electrical currents flowing through the busbar and the conducting lines is avoided.

According to an embodiment, each of the FFCs is electrically connected to a plurality of the sensor devices, current collector devices, and/or battery cells. This enables an efficient routing of the conductor lines because each of the FFCs includes a plurality of conductor lines, which can be routed by the FFC. In some embodiments, each of the FFCs is electrically connected to a number of the sensor devices, current collector devices, and/or battery cells that equals the number of conductor lines provided by the respective FFC.

According to an embodiment, the battery cells and the sensor devices and/or current collector devices are arranged in a plurality of cell stacks, and the FPC is arranged to reach the plurality of cell stacks. Thus, battery cells are arranged in a stacked manner (or arrangement). The sensor devices are arranged between the battery cells and/or between cell stacks. The FPC is arranged so that the conductor lines can be routed via the FFCs to each of the cell stacks. For example, the FPC is elongated in an extension direction so that the FPC spans over the cell stacks which are connected to the FPC. This allows an efficient arrangement of the FPC and ensures that any functional entity or device, such as the battery cells, the sensor devices, and/or current collector devices, can be electrically interconnected with the BMM in an efficient manner.

According to an embodiment, each of the FFCs is electrically connected to the battery cells, the sensor devices, and/or the current collector devices of the same battery cell stack. Thus, the FFCs can be arranged to extend in an extension direction of the battery cell stack. The FPC is arranged so that every cell stack is reached, and the FFCs branching of the FPC and extend and are arranged so that any functional entity within the cell stack is reached.

According to an embodiment, the flexible conductor arrangement is electrically connected to a single BMM. For example, the BMM is interconnected to the battery cells, the sensor devices, and/or the current collector devices via the FPC and a plurality of FFCs. Thus, only the FPC needs to be connected to the BMM, which enables an efficient layout and manufacture of the battery pack.

According to an embodiment, the battery pack includes a battery disconnect unit (BDU), and the BDU includes the BMM. This facilitates an efficient layout of the battery pack and further simplifies routing of the FPC.

According to an embodiment, each of the FPC and the plurality of FFCs has an elongated shape defining a principal extension direction, and the FPC and the plurality of FFCs are arranged so that the principal extension direction of the FPC is perpendicular to the principal extension direction of each of the plurality of FFCs. For example, each of the FFCs is arranged perpendicular to the FPC. This allows for an efficient arrangement of the flexible conductor arrangement by routing the FPC so that the FPC reaches each of the cell stacks and by routing the FFCs so that each of the FFCs reach functional entities to be contacted at one of the cell stacks.

According to an embodiment, the FPC includes an electrical connector to electrically interconnect the FPC and the BMM with each other in a reversible manner. Accordingly, the BMM can be easily dismounted from and mounted to the battery pack, such as for maintenance.

According to an embodiment, each of the FFCs is welded to the FPC. The FFCs can be welded at the branch portions to the FPC. Each of the branch portions has a plurality of contact portions at which one of the conducting lines provided by one of the FFCs can be welded. This enables an efficient and reliable electrical interconnection between the FPC and the FFCs.

According to an embodiment, the FPC includes an electronics device. The electronics device may include a data processing device and/or a sensing device that process and/or acquire data. The data processing device can be configured to evaluate signals acquired by the sensor devices within the cell stacks and to transmit evaluation results to the BMM. This can reduce and/or make more efficient the data transfer between the sensor devices and the BMM.

According to another embodiment of the present disclosure, an electric vehicle includes a battery pack as described above. The battery pack of the electric vehicle may include any of the aforementioned features to achieve the associated aspects and features.

Yet another embodiment of the present disclosure provides a method for assembling a battery pack. The method includes the steps of: providing a plurality of battery cells, a battery management module (BMM), a plurality of sensor devices and/or current collector devices, and a flexible conductor arrangement including a plurality of branched conductor lines, and the flexible conductor arrangement includes a flexible printed circuit (FPC) and a plurality of flexible flat cables (FFCs) connected to the FPC, and the conductor lines are routed along the FPC and branch into the plurality of FFCs; and electrically interconnecting each of the sensor devices and/or current collector devices with the BMM by one of the conductor lines via the FPC and via one of the FFCs. The method may include steps to assemble a battery pack including any of the aforementioned features to achieve the associated aspects and features. For example, the flexible conductor arrangement may include any of the aforementioned features to achieve the associated aspects and features.

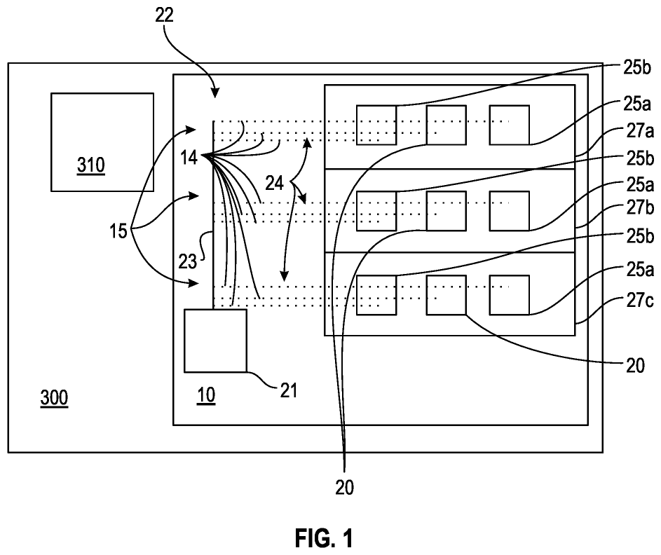

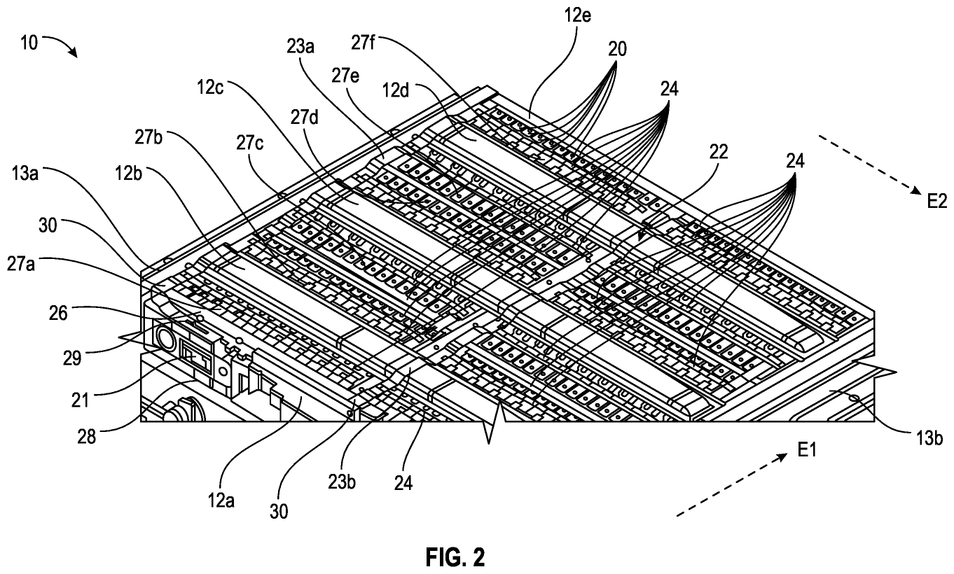

FIG. 1 is a schematic view of an electric vehicle 300 according to an embodiment of the present disclosure. The electric vehicle 300 is propelled by an electric motor 310 using energy stored in rechargeable batteries cells 20 arranged in a battery pack 10. The battery cells 20 are arranged in a stacked manner (or arrangement) in cell stacks 27a, 27b, 27c. In FIG. 1, only one battery cell 20 per cell stack 27a, 27b, 27c is indicated for an illustrative purpose. FIGS. 2 to 4 show additional battery cells 20 per cell stack 27a, 27b, 27c.

The battery pack 10 includes a battery management module (BMM) 21, a plurality of sensor devices 25a, and a plurality of current collector devices 25b. The current collector devices 25b can be configured to electrically interconnect a subset of the battery cells 20 within one of the cell stacks 27a, 27b, 27c with each other. For example, a current collector device 25b can be configured to electrically interconnect a plurality of (e.g., six) battery cells 20 within one of the cell stacks 27a, 27b, 27c with each other. This reduces the number of conductor lines necessary to obtain the electrical power of the battery cells 20 as compared to connecting each of the battery cells 20 individually. The sensor devices 25a include temperature sensing devices, and each of the temperature sensing devices is configured to measure the temperature within the battery pack 10. As shown in FIG. 1, within one of the cell stacks 27a, 27b, 27c, the temperature of one of the battery cells 20 or between a pair of cell stacks 27a, 27b, 27c is measured.

To electrically connect the battery cells 20, the sensor devices 25a, and the current collector devices 25b with the BMM 21, the battery pack 10 includes a flexible conductor arrangement 22 including a plurality of branched conductor lines 14.

The flexible conductor arrangement 22 includes a flexible printed circuit (FPC) 23 and a plurality of flexible flat cables (FFCs) 24 connected to the FPC 23. The FPC 23 is indicated by a dashed line in FIG. 1. The FPC 23 includes a plurality of branch portions 15. At each of the branch portions 15, one of the FFCs 24 is connected to the FPC 23. The FPC 23 and the FFCs 24 provide (or form) the conductor lines 14.

The conductor lines 14 are routed along the FPC 23 and branch at the branch portions 15 into the plurality of FFCs 24. Each of the FFCs 24 is indicated by the plurality of conductor lines 14 with dotted lines in FIG. 1. Thus, at each of the branch portions 15, the plurality of conductor lines 14 are routed from the FPC 23 to one of the FFCs 24. Each of the conductor lines 14 electrically connects the BMM 21 via the FPC 23 and via one of the FFCs 24 with one of the sensor devices 25a, one of current collector devices 25b, and/or one of the battery cells 20.

FIG. 2 is a perspective view of a portion of a battery pack 10 according to an embodiment.

The battery pack 10 includes a battery management module (BMM) 21 and a battery disconnect unit (BDU) 28. The BDU 28 includes the BMM 21. Only one central BMM 21 may be provided in the battery pack 10 to obtain and process data acquired within the battery pack 10.

The battery pack 10 includes a plurality of sensor devices 25a, a plurality of current collector devices 25b, and a plurality of battery cells 20. The battery cells 20, the sensor devices 25a, and the current collector devices 25b are arranged in a plurality of cell stacks 27a, 27b, 27c, 27d, 27e, 27f. Therein, each of the current collector devices 25b is configured to electrically interconnect a subset of the battery cells 20 within one of the cell stacks 27a, 27b, 27c, 27d, 27e, 27f with each other.

The battery pack 10 includes a flexible conductor arrangement 22 arranged to span the battery pack 10 so that each of the cell stacks 27a, 27b, 27c, 27d, 27e, 27f is reached by the flexible conductor arrangement 22. The flexible conductor arrangement 22 includes a plurality of conductor lines 14.

The flexible conductor arrangement 22, according to an embodiment, includes two flexible printed circuits (FPCs) 23a, 23b and a plurality of flexible flat cables (FFCs) 24. In this embodiment, the FPCs 23a, 23b are of different type. For example, the shape and geometry of the FPCs 23a, 23b are substantially the same, except one of the FPCs 23a includes a connection portion 29 to connect the FPC 23a to the BDU 28.

Each of the FFCs 24 is connected to one of the FPCs 23a, 23b. Each of the FPCs 23a, 23b includes a plurality of branch portions 15 (see, e.g., FIGS. 1, 3, and 5). At each of the branch portions 15, one of the FFCs 24 is connected to the corresponding FPC 23a, 23b. The FPCs 23a, 23b and the FFCs 24 provide the plurality of conductor lines 14. To electrically connect the battery cells 20, the sensor devices 25a, and the current collector devices 25b with the BMM 21, the plurality of branched conductor lines 14 is provided by the FPCs 23a, 23b and the FFCs 24.

The conductor lines 14 are routed along the FPCs 23a, 23b and branch at the branch portions 15 into the plurality of FFCs 24. Thus, at each of the branch portions 15 of each of the FPCs 23a, 23b, conductor lines 14 are routed from the corresponding FPC 23a, 23b to one of the FFCs 24. The number of branch portions 15 equals the number of FFCs 24. Each of the conductor lines 14 electrically interconnects the BMM 21 via one of the FPC 23a, 23b and via one of the FFCs 24 with one of the sensor devices 25a, one of current collector devices 25b, and/or one of the battery cells 20.

Each of the FPCs, 23a, 23b includes a plurality of electrically conducting layers that are separated from each other by an electrically isolating layer. Each of the FFCs 24 is electrically connected to one of the electrically conducting layers of one of the FPCs, 23a, 23b and to each of the electrically conducting layers of each of the FPCs 23a, 23b one of the FFCs 24 is connected. Thus, due to the FPCs 23a, 23b providing the plurality of electrically conducting layer, the FPCs 23a, 23b may have a relatively small width because the conductor lines 14 are arranged in the plurality of electrically conducting layers instead of only in one electrically conducting layer. Each of the FFCs 24 is welded to the FPC 23 at one of the branch portions 15.

The battery cells 20 are electrically interconnected by a busbar 26, and each of the FPCs, 23a, 23b includes a metal portion arranged at a welding position 30, electrically isolated from the conductor lines 14, and welded to the busbar 26.

Each of the FFCs 24 is electrically connected to a plurality of the sensor devices 25a, current collector devices 25b, and/or battery cells 20. The FPCs 23a, 23b are arranged to reach each of the plurality of cell stacks 27a, 27b, 27c, 27d, 27e, 27f. Each of the FFCs 24 is electrically connected to the battery cells 20, the sensor devices 25a, and/or the current collector devices 25b of the same battery cell stack 27a, 27b, 27c, 27d, 27e, 27f.

The FPCs 23a, 23b and the plurality of FFCs 24 have an elongated shape respectively defining a principal extension direction E1, E2. For example, the FPCs 23a, 23b are arranged to primarily extend along a first extension direction E1, and the plurality of FFCs 24 is arranged to primarily extend along a second extension direction E2. The FPCs 23a, 23b and the plurality of FFCs 24 are arranged so that the first extension direction E1 of the FPCs 23a, 23b is perpendicular to the second extension direction E2 of each of the plurality of FFCs 24. For example, at each of the branch portions 15, one of the FFCs 24 branches off from one of the FPCs 23a, 23b to extend perpendicular from the respective FPC 23a, 23b. Each of the first extension direction E1 and the second extension direction E2 is indicated in the figures by a dashed arrow.

Each of the FFCs 24 is commonly connected to one of the FPCs 23a, 23b arranged at the same site of the respective FPC 23a, 23b. For example, the FFCs 24 do not branch off the FPC 23a, 23b in opposing directions but in the same direction and parallel to each other.

The FPC 23a includes an electrical connector to electrically interconnect the FPC 23a and the BMM 21 with each other in a reversible manner at the connection portion 29.

The battery pack 10 includes, in the illustrated embodiment, six rows of cell stacks 27a, 27b, 27c, 27d, 27e, 27f. To provide structural support for the battery pack and for retaining the cell stacks 27a, 27b, 27c, 27d, 27e, 27f, the battery pack 10 includes two longitudinal beams 13a, 13b and a plurality of crossbeams 12a, 12b, 12c, 12d, 12e arranged between and connected to the longitudinal beams 13a, 13b.

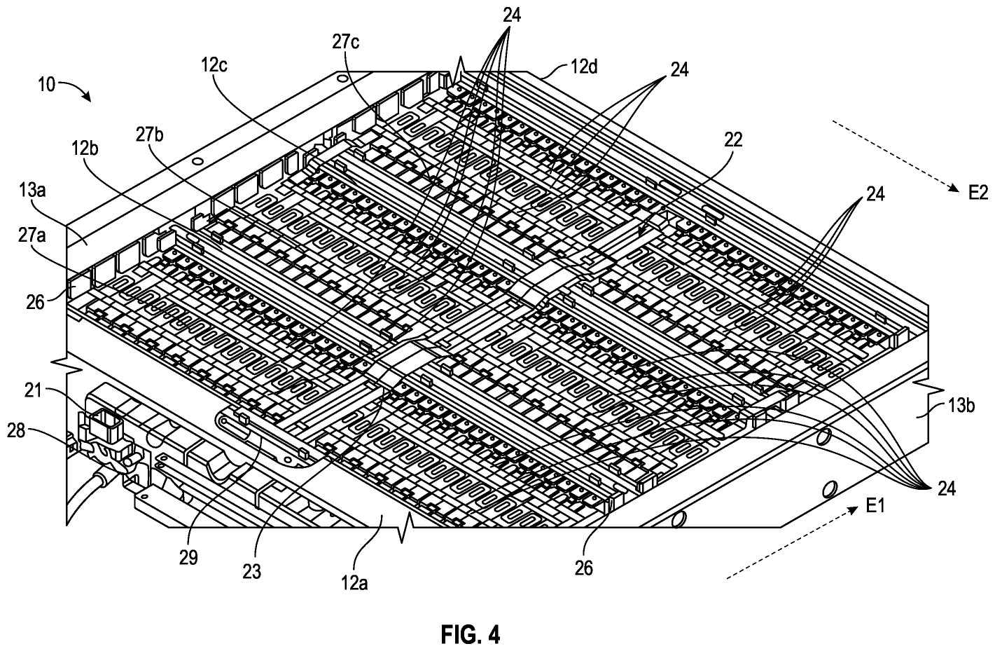

The crossbeams 12a, 12b, 12c, 12d, 12e are arranged in parallel to each other, and the plurality of crossbeams 12a, 12b, 12c, 12d, 12e includes two outer crossbeams 12a, 12e and, in the illustrated embodiment, three inner crossbeams 12b, 12c, 12d. The battery pack 10, according to other embodiments, may include a different number of crossbeams 12a, 12b, 12c, 12d and/or differently-sized longitudinal beams 13a, 13b to provide a differently sized battery pack 10 (see, e.g., FIG. 4).

The cell stacks 27a, 27b, 27c, 27d, 27e, 27f and the three inner crossbeams 12b, 12c, 12d are alternately stacked between the two outer crossbeams 12a, 12e. Compartments to retain the cell stacks 27a, 27b, 27c, 27d, 27e, 27f are provided between (or are formed between) any neighboring pair of crossbeams 12a, 12b, 12c, 12d, 12e.

The length of each of the crossbeams 12a, 12b, 12c, 12d, 12e in the second extension direction E2 from one of the longitudinal beams 13a to the other longitudinal beam 13b is the same or substantially the same as the length of the rows of cell stacks 27a, 27b, 27c, 27d, 27e, 27f so that the rows of cell stacks 27a, 27b, 27c, 27d, 27e, 27f can be arranged and retained between the pairs of crossbeams 12a, 12b, 12c, 12d, 12e.

The two longitudinal beams 13a, 13b are arranged in parallel to each other, and each of the two longitudinal beams 13a, 13b is elongated in the first extension direction E1. The crossbeams 12a, 12b, 12c, 12d, 12e are arranged in parallel to each other, and each of the crossbeams 12a, 12b, 12c, 12d, 12e is elongated in the second extension direction E2. For example, the crossbeams 12a, 12b, 12c, 12d, 12e and the two longitudinal beams 13a, 13b are arranged perpendicular to each other. Thus, compartments with a rectangular cross-section to retain the cell stacks 27a, 27b, 27c, 27d, 27e, 27f are formed in the battery pack 10.

Each of the crossbeams 12a, 12b, 12c, 12d, 12e is connected to the two longitudinal beams 13a, 13b by a plurality of fasteners extending in the second extension direction E2 through the longitudinal beams 13a, 13b and into the crossbeams 12a, 12b, 12c, 12d, 12e. The longitudinal beams 13a, 13b have openings through which the fasteners extend into the crossbeams 12a, 12b, 12c, 12d, 12e.

The longitudinal beams 13a, 13b and the crossbeams 12a, 12b, 12c, 12d, 12e are, in one embodiment, extruded beams. The number of inner crossbeams 12b, 12c, 12d equals the number of cell stacks 27a, 27b, 27c, 27d, 27e, 27f minus one. Each of the cell stacks 27a, 27b, 27c, 27d, 27e, 27f is mounted between a pair of adjacent crossbeams 12a, 12b, 12c, 12d, 12e.

In an embodiment, data transfer between the sensor devices 25a, one of current collector devices 25b, and/or one of the battery cells 20 and the BMM 21 can be routed via the flexible conductor arrangement 22 over venting channels, which can be fulfilled with the flexible conductor arrangement 22.

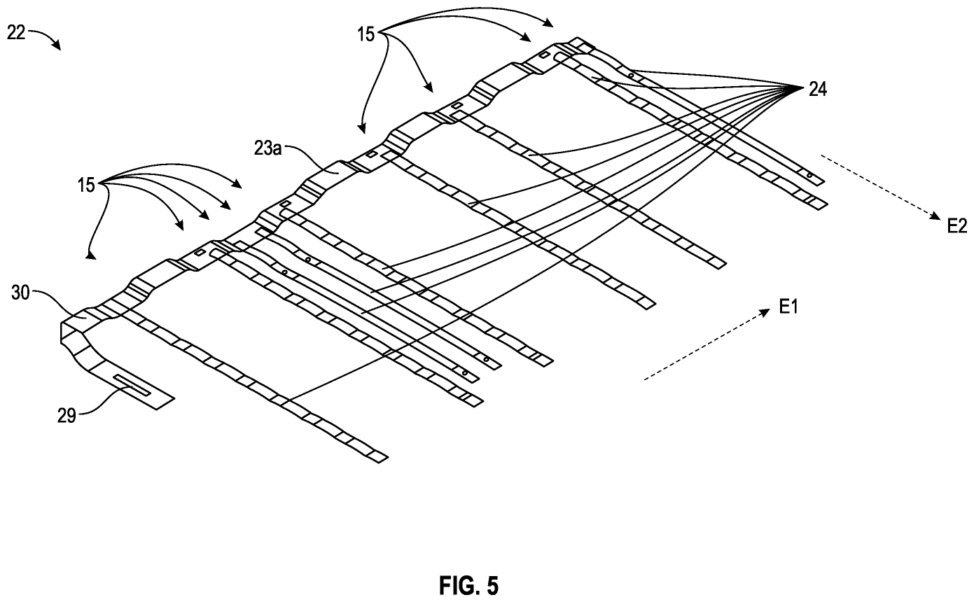

The FPCs 23a, 23b have a non-planer shape. For example, the FPCs 23a, 23b may be shaped and arranged to match the shape of a contacting surface between the FPCs 23a, 23b and any underlying components of the battery pack 10, such as the cell stacks 27a, 27b, 27c, 27d, 27e, 27f and crossbeams 12a, 12b, 12c, 12d, 12e (see, e.g., FIG. 5).

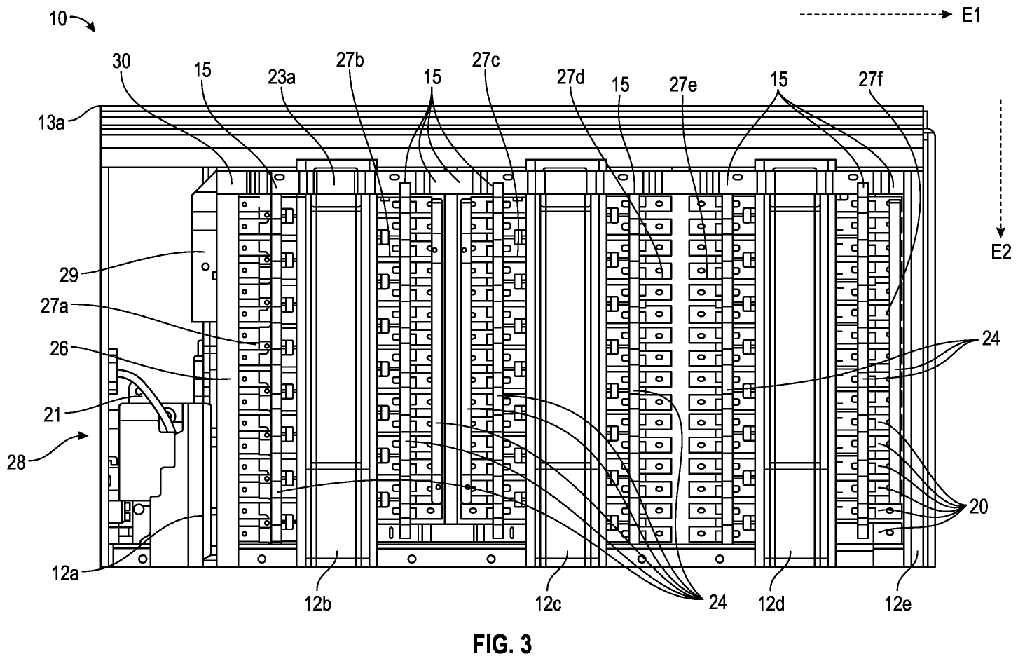

FIG. 3 is a top view of a portion of the battery pack 10 shown in FIG. 2. FIG. 2 illustrates the arrangement of the flexible conductor arrangement 22 with regard to the FPC 23a and the FFCs 24 connected thereto. For example, the FPC 23a and the FFCs 24 are arranged to extend perpendicular to each other. The FPC 23a is arranged to span over each of the cell stacks 27a, 27b, 27c, 27d, 27e, 27f. For example, the extension (or length) of the FPC 23a in the first extension direction E1 matches the width of the cell stacks 27a, 27b, 27c, 27d, 27e, 27f and the crossbeams 12b, 12c, 12d arranged between the cell stacks 27a, 27b, 27c, 27d, 27e, 27f. The FPC 23a includes a number of branch portions 15 that is greater than the number of cell stacks 27a, 27b, 27c, 27d, 27e, 27f. Thus, at each of the cell stacks 27a, 27b, 27c, 27d, 27e, 27f, at least one of the FFCs 24 branches off the FPC 23a to reach into the cell stacks 27a, 27b, 27c, 27d, 27e, 27f and connect to one of the sensor devices 25a, one of current collector devices 25b, and/or one of the battery cells 20 of the respective cell stack 27a, 27b, 27c, 27d, 27e, 27f. For example, two branch portions 15 are provided so that two of the FFCs 24 reach the respective cell stack 27b, 27c, 27f to provide conductor lines 14 for temperature measurement by the sensor devices 25a and for current collection by the current collector devices 25b within the same cell stack 27b, 27c, 27f.

FIG. 4 is a perspective view of a portion of a battery pack 10 according to an embodiment.

The battery pack 10 shown in FIG. 4 is described with reference to the embodiment shown in FIGS. 2 and 3, with the differences therebetween being primarily described.

The battery pack 10 includes a flexible conductor arrangement 22, and the flexible conductor arrangement 22 includes one FPC 23. The FPC 23 is centrally arranged. For example, the FPC 23 is arranged in a central section of each of the battery cell stacks 27a, 27b, 27c and of the crossbeams 12a, 12b, 12c. The FFCs 24 connected the FPC are arranged at the opposite sites of the FPC 23. For example, the FFCs 24 branch off the FPC 23 in opposing directions and parallel to each other. The FFCs 24 branch off in pairs, for example, at each branch portion 15 of the FPC 23, a pair of FFCs 24 branches off the FPC 23 in opposite directions.

The battery pack 10 includes fewer crossbeams 12a, 12b, 12c, 12d and cell stacks 27a, 27b, 27c as compared to the embodiment shown in FIGS. 2 and 3.

FIG. 5 is a perspective view of a flexible conductor arrangement 22. The flexible conductor arrangement 22 is described with reference to the embodiment shown in FIGS. 2 and 3.

In FIG. 5, the branch portions 15 are indicated. At each of the branch portion 15, one of the FFCs 24 is arranged to extend perpendicularly from the FPC 23a.

The FPCs 23a have a non-planer shape. For example, the FPC 23a is flexible and arranged and/or shaped to match the shape of a contacting surface between the FPC 23a and any underlying components of the battery pack 10. Thus, the FPC 23a has an undulating shape in the first extension direction E1. For example, the FPC 23a extends in an alternating manner in a direction being perpendicular to the first extension direction E1 and to the second extension direction E2.

In the first extension direction E1, the branch portions 15 are distributed (or arranged) with different distances from each other. For example, the FFCs 24 branch off the FPC 23a at different distances from each other (or at different intervals) to provide an arrangement of conductor lines 14 for the corresponding battery pack 10.

### SOME REFERENCE SIGNS

10 battery pack
12a, 12b, 12c, 12d, 12e crossbeam
13a, 13b longitudinal beam
14 conductor line
15 branch portion
21 battery management module (BMM)
22 flexible conductor arrangement
23, 23a, 23b flexible printed circuit (FPC)
24 flexible flat cable (FFC)
25a sensor device
25b current collector device
26 busbar
27a, 27b, 27c, 27d, 27e, 27f cell stack
28 battery disconnect unit (BDU)
29 connection portion
welding position
E1, E2 extension direction
300 electric vehicle
310 electric motor

What is claimed is:

1. A battery pack comprising:
a plurality of battery cells;
a battery management module (BMM);
a plurality of sensor devices and/or a plurality of current collector devices; and
a flexible conductor arrangement comprising a plurality of conductor lines, a flexible printed circuit (FPC), and a plurality of flexible flat cables (FFCs) connected to the FPC,
wherein the conductor lines are routed along the FPC and branch into the plurality of FFCs, and
wherein each of the conductor lines electrically interconnects the BMM with one of the sensor devices, one of the current collector devices, and/or one of the battery cells via the FPC and via one of the FFCs.

2. The battery pack as claimed in claim 1, wherein the FPC comprises a plurality of electrically conducting layers that are separated from each other by an electrically isolating layer.

3. The battery pack as claimed in claim 2, wherein one of the plurality of FFCs is electrically connected to each of the electrically conducting layers of the FPC.

4. The battery pack as claimed in claim 1, wherein the battery cells are electrically interconnected by a busbar, and
wherein the FPC comprises a metal portion arranged at a welding position, electrically isolated from the conductor lines, and welded to the busbar.

5. The battery pack as claimed in claim 1, wherein the battery cells are electrically interconnected by a busbar, and
wherein the busbar comprises a metal portion arranged at a welding position, electrically isolated from the conductor lines, and welded to the FPC.

6. The battery pack as claimed in claim 1, wherein each of the FFCs is electrically connected to a plurality of the sensor devices, the current collector devices, and/or the battery cells.

7. The battery pack as claimed in claim 1, wherein the battery cells and the sensor devices and/or current collector devices are arranged in a plurality of cell stacks, and
wherein the FPC is arranged to reach the plurality of cell stacks.

8. The battery pack as claimed in claim 7, wherein each of the FFCs is electrically connected to the battery cells and the sensor devices and/or the current collector devices of the same battery cell stack.

9. The battery pack as claimed in claim 1, wherein the flexible conductor arrangement is electrically connected to a single BMM.

10. The battery pack as claimed in claim 1, wherein the battery pack further comprises a battery disconnect unit (BDU), and wherein the BDU comprises the BMM.

11. The battery pack as claimed in claim 1, wherein each of the FPC and the plurality of FFCs has an elongated shape in a principal extension direction, and
wherein the FPC and the plurality of FFCs are arranged so that the principal extension direction of the FPC is perpendicular to the principal extension direction of each of the plurality of FFCs.

12. The battery pack as claimed in claim 1, wherein the FPC comprises an electrical connector to electrically interconnect the FPC and the BMM with each other in a reversible manner.

13. The battery pack as claimed in claim 1, wherein each of the FFCs is welded to the FPC.

14. The battery pack as claimed in claim 1, wherein the FPC comprises an electronic device.

15. An electric vehicle comprising the battery pack according to claim 1.

16. A method for assembling a battery pack, the method comprising:
providing a plurality of battery cells, a battery management module (BMM), a plurality of sensor devices and/or a plurality of current collector devices, and a flexible conductor arrangement, the flexible conductor arrangement comprising a plurality of conductor lines, a flexible printed circuit (FPC), and a plurality of flexible flat cables (FFCs) connected to the FPC, the conductor lines being routed along the FPC and branching into the plurality of FFCs; and
electrically interconnecting each of the sensor devices, the current collector devices, and/or the battery cells with the BMM by one of the conductor lines via the FPC and via one of the FFCs.
